(19) United States
(12) Patent Application Publication
(10) Pub. No.: US 2001/0043837 A1
(43) Pub. Date: Nov. 22, 2001

(54) Device for laying a cable or a protective sheathing

(76) Inventors: Wolfgang Teschner, Wunstorf (DE); Wolfgang Liese, Gehrden (DE)

Correspondence Address: SUGHRUE, MION, ZINN, MACPEAK & SEAS, PLLC, 2100 PENNSYLVANIA AVENUE, N.W., WASHINGTON, DC, 20037-3213, US

(21) Appl. No.: 09/836,337

(22) Filed: Apr. 18, 2001

(30) Foreign Application Priority Data
Apr. 22, 2000 (DE) 100 19 977.1

(51) Int. Cl. F16L 1/00

(52) U.S. Cl. 405/183.5; 405/184

(57) ABSTRACT

In a process for laying a cable, or a protective sheathing for a cable core to be introduced into the protective sheathing at a later time, in a sewage pipe, the cable or the protective sheathing is fixed at particular spacings along the inside wall of the sewage pipe by means of clips. Here, the cable or the protective sheathing is diverted in the region of house lead-ins, so that the cable or the protective sheathing by-passes the house lead-in. The mutual spacing between the clips is substantially smaller in the region of the diversion than in the region of the straight path of the cable or the protective sheathing. The cable or the protective sheathing is anchored in the shafts and is pre-tensioned with a force of at least 250 N.

### BACKGROUND OF INVENTION

The invention relates to a process for laying a cable or a protective sheathing according to claim 1, and a cable or a protective sheathing for use in this process according to claim 5.

Owing to the expense and length of time involved in licensing procedures for digging work, there is an increasing search for alternatives to this conventional manner of laying cables. For example, existing routes, lines and pipes are lately being equipped with cables and given additional uses without the need for underground engineering.

The requirements for a laying process within channels, lines and pipes can be summarised as follows:

1 . The cable or conduit should be guided along the vertex region of the channel, avoiding sag and the collection of solids and deposits.

2. Built-in components should not substantially impede functioning and maintenance of the channel operation. The accumulation of solids, formation of plugs and impediments to repair, restoration, cleaning and inspection should be prevented.

3. There should be no weakening of, or damage to, the channel structure.

4. There should be no significant reduction in the channel cross-section.

5. It should be possible to guide the cable routes in the channel around lead-ins.

EP 0 251 907 B1 discloses a process for laying a cable in a pipe, in which a carriage which may be driven along the inside of the pipe lifts up the cable by means of a front arm and presses it against the inside wall of the pipe, and a device bores holes in the wall and fixes the cable by means of a clamp which may be guided into the bores.

WO 98/32043 discloses a process for laying optical-fibre cables in non-accessible channel or pipe systems which are used for other purposes, the cables being introduced into, and fixed in, the channel with the aid of a remote-controllable channel robot. Fixing elements (clips) are first of all fixed to the inside wall of the channel and then the optical-fibre cable is clamped in receiving means, provided for this, in the fixing elements. The fixing means are formed by a resiliently pre-tensioned, closed high-grade steel ring, which presses against the channel wall as a result of its pre-tension. The receiving means for the optical-fibre cables are constructed as snap-type clamping means. This process has proven effective since it is not necessary to reach into the channel wall and there is only an insignificant reduction in the flow cross-section of the channel.

Finally, EP 0 942 504 A1 discloses a process for fixing cables in channel or pipe systems, in which a strain-resistant element, for example a messenger, is tensioned between accessible points within the cable and pipe system and the cable is attached to the messenger. An alternative to this describes using a cable or a stretched-out hollow profile having at least one strain-resistant element, and tensioning the strain-resistant element. This process deliberately dispenses with additional fixing elements. This process is disadvantageous in that, in particular with spacings of more than 50 m between the anchoring points (shafts), high tensile forces are necessary to prevent an undesirable, large sag. The high anchoring forces necessitate a cable which is capable of withstanding great strain, i.e. there has to be a correspondingly high proportion of tensile elements in the cable. This results in the cable being relatively heavy, which in turn increases the sag. A serious disadvantage of this process, however, is that it is not possible to divert the cable in the region of house lead-ins, with the result that coarse material can accumulate in this region and possibly result in a blockage in the region of the house service connection. Moreover, the high tensile forces necessitate special constructional measures in the shafts.

### SUMMARY OF THE INVENTION

Taking the prior art according to WO 98/32043 as a starting point, the object of the present invention is to provide a simplified process for laying cables or the like in sewers, in which the number of fixing means can be reduced without increasing the sag of the cable, and in which the cable or the like can easily be guided around house lead-ins and can be installed such that it is flexible and has small bending radii in the access region to the channel.

This object is achieved by the features of claim 1.

According to the process, it is possible to lay a cable which has already been manufactured at the factory, or an armoured conduit is laid according to the teaching of the invention and a cable core is subsequently introduced into the laid conduit, for example by sliding, blowing or flushing. Since it is possible for the clips to become displaced in the peripheral direction when the cable or conduit is pre-tensioned—whereby the cable or the conduit then arrives in the opening of the house lead-in—it is advantageous if the clips are fixed to the channel wall at least in the vicinity of the house lead-in, for example as a result of adhesion or a claw-type action or by providing that part of the clips which faces the channel wall with a structured surface. A further advantage of the invention can be seen in that it is possible to optimise both the number of clips between two shafts and the anchoring force, which in turn results in a simplified construction of the cable. It is moreover possible to improve the laying efficiency and thus to achieve greater economy. The process according to the invention can be carried out with or without robots.

Further advantageous constructions of the invention are included in the sub-claims.

### DESCRIPTION

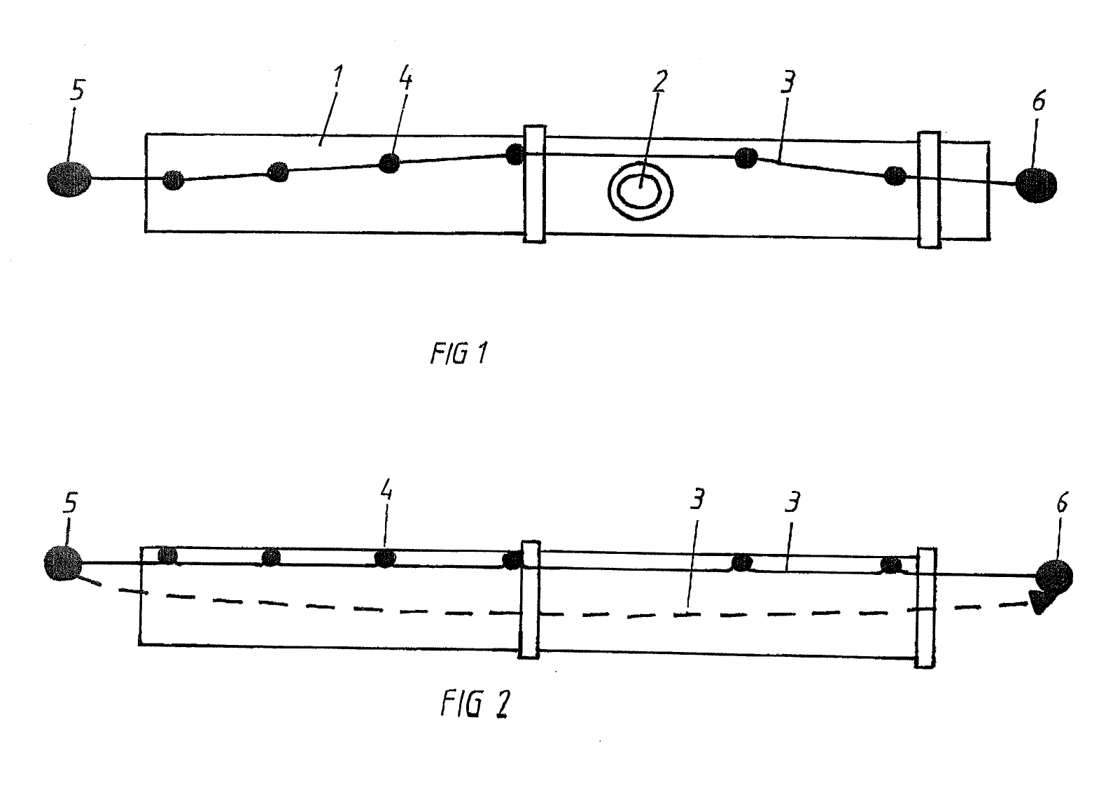

The invention is explained in more detail with reference to the exemplary embodiments illustrated schematically in FIGS. 1 to 3, in which:

FIG. 1 shows a plan view of a sewer;

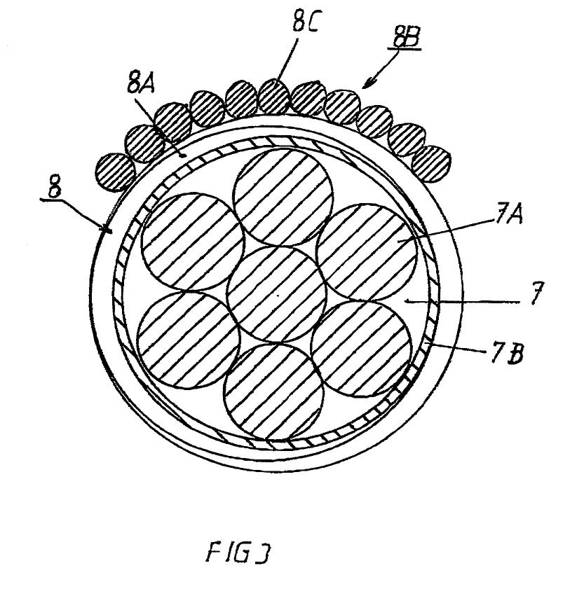

FIG. 2 shows a side view of a sewer; and

FIG. 3 shows a section through a cable.

1 denotes a sewer to which sewage is supplied through so-called house lead-ins 2. The cable 3 laid in the sewer 1 is fixed along the vertex of the sewer 1, that is to say at the point where the house lead-ins 2 are normally located. The cable 3 is laid by means of clips 4. In order to reduce the number of clips 4, the cable 3 is clamped at the anchoring points 5 and 6 and is pre-tensioned with a force of for example 200 N. So that the cable 3 does not impede the opening of the house lead-in 2, the clips 4 in the vicinity of the house lead-in 2 are inserted in the sewage pipe in such a way that the cable 3 by-passes the house lead-in, that is to say it is diverted from its position along the vertex of the sewage pipe.

FIG. 2 shows the difference between a laying procedure having compatible tensile forces without clips 4 (dashed line) and with clips 4 (continuous line). During the laying procedure, the clips 4 are first of all mounted in torsion-resistant manner on the inner surface of the sewage pipe 1 by means of a robot, and, in the same operation, the cable 1 or a protective sheathing for a cable core to be introduced later is placed in the receiving means, provided for this, in the clips.

In the immediate vicinity of the house lead-in 2, i.e. at the point where the cable 3 is diverted from its straight course, the spacing between the clips 4 is approximately 2-5 m, whereas the mutual spacing between the clips 4 in the non-diverted region can be 10-20 m, depending on the extent of the tensile force.

FIG. 3 shows a section through a cable 3, which is particularly suitable for laying in sewage pipes 1.

The cable 3 comprises a cable core 7 and a protective sheathing 8. The cable core 7 can be of any type of construction, for example a group of strands, a grooved profile etc. However, it is preferably a bundle of a plurality of buffered fibres 7a, for example six buffered fibres, which are placed around a central element (not illustrated in more detail) in conductive manner. The cable core 7 is surrounded by a common casing 7b. Instead of the casing, the bundle can also be held together by a tape lapping. Each buffered fibre 7a contains for example 24 optical-fibres (not illustrated). Therefore, the cable has a total of 144 optical-fibres. The spaces between the buffered fibres 7a can be filled with a material for providing longitudinal water-tightness. The casing 7b is made of for example polyamide, polyethylene or another suitable material.

The protective sheathing 8 comprises a conduit 8a which is resistant to transverse pressure and is preferably a longitudinally seam-welded and corrugated conduit of stainless steel.

To enable the anchoring forces to be absorbed, an armouring 8b comprising one or two layers of metal wires 8c is deposited on the conduit 8a. The wires 8c are preferably likewise made of stainless steel. The wires 8c are placed on the conduit 8a in conductive manner, such that they have a length of lay I which is greater than the external diameter of the conduit 8a, at the most by a factor of 10. The diameter of the wires 8c is approximately 10% of the external diameter of the conduit 8a.

A preferred embodiment of the cable has the following dimensions.

| | |
|---|---|
| External diameter of the buffered fibres 7a: | 2.8 mm |
| External diameter of the casing 7b: | 11.0 mm |
| External diameter of the conduit 8a: | 14.0 mm |
| External diameter of the wires 8c: | 0.8 mm |
| Length of lay of the wires 8c: | 70.0 mm |

This results in a external cable diameter of 15.5 mm.

In order to prevent damage to the corrugated conduit 8a upon anchoring, the number of wires 8c of the armouring 8 is such that the wires 8c lie tightly against the conduit 8a.

1. A process for laying a cable, or a protective sheathing for a cable core to be introduced into the protective sheathing at a later time, in a sewage pipe, preferably a non-accessible sewage pipe, in which the cable or the protective sheathing is fixed at particular spacings along the inside wall of the sewage pipe by means of clips,
wherein
diverting the cable or the protective sheathing is in the region of house lead-ins, so that the cable or the protective sheathing by-passes the house lead-in, in that the mutual spacing between the clips is substantially smaller in the region of the diversion than in the region of the straight course of the cable or the protective sheathing,
and anchoring the cable or the protective sheathing is in the shafts and is pre-tensioned with a force of at least 250 N.

2. A process according to claim 1, wherein the clips in the region of the straight course of the cable or the conduit are spaced at least 10 m, preferably at least 20 m, apart.

3. A process according to claim 1, wherein the maximum sag after pre-tensioning of the cable or the conduit is less than 2 cm.

4. A process according to one of claims 1, wherein more than one cable or conduit is laid in the sewage pipe.

5. A protective sheathing for a cable core to be laid along the inside wall of waste-disposal pipes, preferably sewage pipes, according to one of claims 1 comprising a conduit (8a) having a transverse-pressure resistance of greater than 100 N/cm² and, located on the conduit (8a), an armouring (8b) of a plurality of individual wires (8c) which are deposited on the conduit (8a) with a length of lay I resulting from a ratio I:D of between 5 and 50, preferably between 10 and 25, D being the external diameter of the conduit (8a).

6. A protective sheathing according to claim 5, wherein the conduit (8a) is made of a ductile metal, such as copper, aluminium or lead.

7. A protective sheathing according to claim 5, wherein the conduit (8a) is a corrugated metal conduit.

8. A protective sheathing according to claim 5, wherein the corrugated conduit (8a) is made of aluminium, an aluminium alloy or stainless steel.

9. A protective sheathing according to claim 5, wherein the ratio of the diameter d of the individual wires (8c) of the armouring (8b) to the external diameter D of the conduit (8a) is between 0.05 and 0.5.

10. A protective sheathing according to one of claim 5, wherein the armouring (8b) is constructed in two layers.

11. A protective sheathing according to one of claim 5, wherein the individual wires (8c) of the armouring (8b) are stainless steel wires.

12. A protective sheathing according to claims 5, wherein the individual wires (8c) of the armouring (8b) are in close contact with the adjacent individual wires (8c) on the conduit surface.
